(19) United States
(12) Patent Application Publication
(10) Pub. No.: US 2026/0358837 A1
(43) Pub. Date: Nov. 12, 2026

(54) REMOTE PARKING-OUT CONTROL DEVICE FOR ELECTRIFIED VEHICLE

(71) Applicant: TOYOTA JIDOSHA KABUSHIKI KAISHA, Toyota-shi (JP)

(72) Inventors: Tatsuya SUGANO, Seto-shi (JP); Takahiro Yamamoto, Toyota-shi (JP); Chenyang Wang, Nagoya-shi (JP)

(73) Assignee: TOYOTA JIDOSHA KABUSHIKI KAISHA, Toyota-shi (JP)

(21) Appl. No.: 19/563,438

(22) Filed: Mar. 11, 2026

(30) Foreign Application Priority Data
May 9, 2025 (JP) 2025-078750

(51) Int. Cl. G05D 1/86; G05D 1/224; H04W 4/40; H04W 4/80; G05D 109/10; G05D 111/30

(52) U.S. Cl. CPC G05D 1/86; G05D 1/2244; H04W 4/40; H04W 4/80; G05D 2109/10; G05D 2111/32

(57) ABSTRACT

A remote parking-out control device for an electrified vehicle includes a control unit configured to be wirelessly connected to a communication terminal device operated by a user and to execute remote parking-out control in response to a command from the communication terminal device, in which the control unit is configured to, after the wireless connection with the communication terminal device is completed, in a case where it is determined that a charging plug is connected to a charging port, issue a command to the communication terminal device to notify a user of a warning that parking-out of an electrified vehicle by the remote parking-out control is disabled and that parking-out of the electrified vehicle by the remote parking-out control is enabled in a case where a connection between the charging plug and the charging port is released.

### CROSS-REFERENCE TO RELATED APPLICATION

This application claims priority to Japanese Patent Application No. 2025-078750 filed on May 9, 2025. The disclosure of the above-identified application, including the specification, drawings, and claims, is incorporated by reference herein in its entirety.

### BACKGROUND

### 1. Technical Field

The present disclosure relates to a remote parking-out control device for an electrified vehicle.

### 2. DESCRIPTION OF RELATED ART

As one example of parking-out control devices for a vehicle such as an automobile, a remote parking-out control device configured, in response to operation of a communication terminal device by a user, to execute remote parking-out control to move the vehicle by autonomous driving to a target parking-out position is known.

In a case where the vehicle is an electrified vehicle, an on-board battery is charged by connecting a charging plug of a charging device to a charging port. In a case where the charging plug is connected to the charging port, parking-out of the vehicle is disabled by the remote parking-out control, so it is necessary to notify the user of the connection of the charging plug to the charging port by the communication terminal device.

For example, as described in paragraph of Japanese Unexamined Patent Application Publication No. 2013-218655 (JP 2013-218655 A), it is known that, in a case of charging an on-board battery, information on an amount of charge of a battery and whether a charging plug is connected to a charging port is transmitted to a communication terminal device to notify a user.

### SUMMARY

In the electrified vehicle, even in a case where determination is made that the charging plug is connected to the charging port before an on-board control device is wirelessly connected to the communication terminal device such that the on-board control device can transmit and receive information, the information cannot be transmitted to the communication terminal device to notify the user. On the contrary, in a case where determination is made that the charging plug is connected to the charging port after the on-board control device is wirelessly connected to the communication terminal device, the information can be transmitted to the communication terminal device to notify the user. However, even in a case where the information on the connection of the charging plug to the charging port is notified, the user cannot determine when to release the connection between the charging plug and the charging port.

The present disclosure provides a remote parking-out control device for an electrified vehicle, which is improved such that, when the charging plug is connected to the charging port, not only is information to that effect notified to a user but the user can also determine when to release the connection.

According to the present disclosure, there is provided a remote parking-out control device (10) for an electrified vehicle (12) in which a battery (18) is charged when a charging plug (54) of a charging device (50) is connected to a charging port (20), the remote parking-out control device including a control unit (control system 24) mounted on the electrified vehicle, the control unit being configured to establish a wireless connection to a communication terminal device (44) operated by a user and to execute remote parking-out control in response to a command from the communication terminal device.

The control unit (control system 24) is configured to, after the wireless connection with the communication terminal device (44) is completed (S10), in a case where determination is made that a connection between the charging plug and the charging port (20) is established (S40), issue a command to the communication terminal device to notify the user of a warning that parking-out of the electrified vehicle (12) by the remote parking-out control is disabled, and that parking-out of the electrified vehicle by the remote parking-out control is enabled in a case where the connection between the charging plug and the charging port is released (S60).

According to the above configuration, in a case where determination is made that the charging plug is connected to the charging port after the wireless connection with the communication terminal device is completed, the warning is notified to the user. The warning includes that parking-out of the electrified vehicle by the remote parking-out control is disabled and that parking-out of the electrified vehicle by the remote parking-out control is enabled in a case where the connection between the charging plug and the charging port is released.

Therefore, since the warning is notified to the user after the wireless connection with the communication terminal device is completed, the user can reliably recognize that the charging plug is connected to the charging port. In addition, since the warning includes that parking-out of the electrified vehicle by the remote parking-out control is disabled, it is possible to prevent the user from parking out the electrified vehicle by the remote parking-out control in a situation where the charging plug is connected to the charging port. Further, since the warning includes that parking-out of the electrified vehicle by the remote parking-out control is enabled in a case where the connection between the charging plug and the charging port is released, the user can determine that parking-out of the electrified vehicle is enabled by releasing the connection between the charging plug and the charging port. Therefore, the user can determine when to release the connection between the charging plug and the charging port.

In one aspect of the present disclosure, the control unit (control system 24) is configured to, in a case where determination is made that the connection between the charging plug and the charging port (20) is released (S40), issue a command to the communication terminal device (44) to notify the user that parking-out of the electrified vehicle by the remote parking-out control is enabled (S100).

According to the above aspect, in a case where determination is made that the connection between the charging plug and the charging port is released, the user is notified that parking-out of the electrified vehicle by the remote parking-out control is enabled. Therefore, the user can determine that parking-out of the electrified vehicle by the remote parking-out control is enabled.

In another aspect of the present disclosure, the control unit (control system 24) is configured to, in addition to the warning, issue a command to the communication terminal device (44) to notify the user of an amount of charge of the battery (S50, S60).

According to the above aspect, in addition to the warning, the amount of charge of the battery is notified to the user. Therefore, in a case where determination is made that the amount of charge of the battery is sufficient, the user performs parking-out of the electrified vehicle by the remote parking-out control, but in a case where determination is made that the amount of charge of the battery is insufficient, the user can hold parking-out of the electrified vehicle by the remote parking-out control until the amount of charge is sufficient.

In another aspect of the present disclosure, the control unit (control system 24) is configured to, before executing the remote parking-out control in response to the command from the communication terminal device (44) (S110), determine whether the charging plug is connected to the charging port (20) (S40).

According to the above aspect, before the remote parking-out control is executed in response to the command from the communication terminal device, determination is made as to whether the charging plug is connected to the charging port. Therefore, it is possible to prevent the user from parking out the electrified vehicle by the remote parking-out control before determination is made as to whether the charging plug is connected to the charging port.

In another aspect of the present disclosure, the control unit (control system 24) is configured to, in a case where determination is made that the connection between the charging plug and the charging port (20) is not released (S40) even after a time equal to or longer than a reference value that is predetermined has elapsed from a time when notification of the warning to the user is started (S80), issue a command to the communication terminal device (44) to notify the user that the remote parking-out control is to be stopped, and then stop the remote parking-out control (S90).

According to the above aspect, in a case where determination is made that the connection between the charging plug and the charging port is not released even after the time equal to or longer than the reference value that is predetermined has elapsed from the time when notification of the warning to the user is started, the user is notified that the remote parking-out control is to be stopped, and then the remote parking-out control is stopped. Therefore, it is possible to prevent a determination as to whether the charging plug is connected to the charging port from continuing for an excessively long period of time, and the user can recognize in advance, before the remote parking-out control is stopped, that the remote parking-out control is to be stopped.

In the above description, in order to facilitate the understanding of the present disclosure, either or both of names and reference numerals used in the embodiment described later are added in parentheses to the configuration of the disclosure corresponding to the embodiment described later. However, each of the components of the present disclosure are not limited to the components of the embodiment corresponding to either or both of the names and reference numerals added in parentheses. Other objects, features, and advantages of the present disclosure will be easily understood from the following description of the embodiments of the present disclosure with reference to the accompanying drawings.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram showing an embodiment of a remote parking-out control device for an electrified vehicle according to the present disclosure;

FIG. 2 is a flowchart corresponding to a remote parking control program in the embodiment;

FIG. 3 is a diagram showing a communication terminal device in which information on an amount of charge of a battery and two warnings are displayed on a monitor;

FIG. 4 is a diagram showing a communication terminal device in which information on the amount of charge of the battery and information that remote parking control in the remote parking-out mode is to be stopped are displayed on the monitor; and

FIG. 5 is a diagram showing a communication terminal device in which information on the amount of charge of the battery and information that the remote parking-out is possible are displayed on the monitor.

### DETAILED DESCRIPTION OF EMBODIMENTS

Hereinafter, a remote parking-out control device for an electrified vehicle according to the embodiment of the present disclosure will be described in detail with reference to the accompanying drawings.

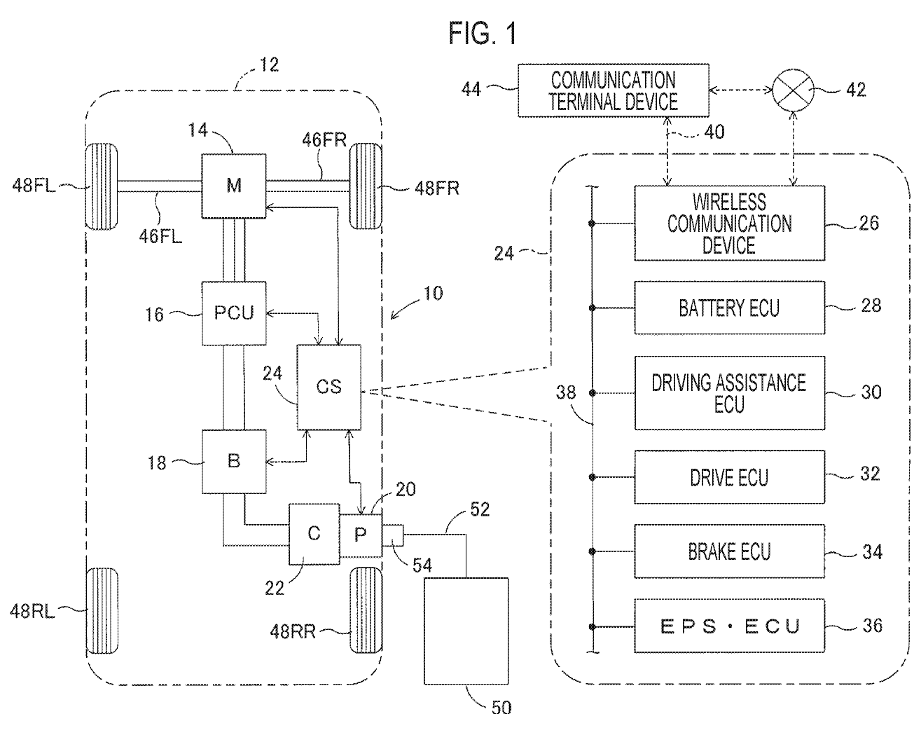

As shown in FIG. 1, the remote parking-out control device 10 according to the embodiment of the present disclosure is applied to an electrified vehicle 12. The electrified vehicle 12 includes an electric motor (M) 14, a power control unit (PCU) 16, a battery (B) 18, a charging port (P) 20, a charger (C) 22, and a control system (CS) 24. The electrified vehicle 12 is a vehicle capable of autonomous driving. It should be noted that the electrified vehicle 12 may be any electrified vehicle as long as the electrified vehicle 12 is a vehicle equipped with a battery to be charged and driven by using the power of the battery.

The control system 24 includes a wireless communication device 26, a battery ECU 28, a driving assistance ECU 30, a drive ECU 32, a brake ECU 34, and an EPS/ECU 36. The ECU means an electronic control unit including a microcomputer as a main part. The EPS is an abbreviation for electric power steering.

The microcomputer of each ECU includes a CPU, a ROM, a RAM, a readable and writable non-volatile memory (N/M), an interface (I/F), and the like. The CPU realizes various functions by executing an instruction (program, routine) stored in the ROM. Further, these ECUs are connected to each other to be capable of exchanging data (communicating) via a controller area network (CAN) 38.

The wireless communication device 26 can communicate with a communication terminal device 44, such as a smartphone, via a short-range communication network 40, such as Bluetooth (registered trademark), or a mobile communication network 42. Although not shown in FIG. 1, the communication terminal device 44 includes a monitor capable of displaying various visual information and a speaker capable of emitting various auditory information. The communication terminal device 44 is operated by the user to transmit and receive signals to and from the wireless communication device 26.

The electric motor 14 is driven by power (three-phase alternating current) supplied from the battery 18 through the power control unit 16 during traction. In the embodiment, the electrified vehicle 12 is a front-wheel drive vehicle, and the electric motor 14 drives left and right drive shafts 46FL and 46FR via a reduction gear and a differential gear (not shown in FIG. 1), thereby driving left and right front wheels 48FL and 48FR. It should be noted that the left and right rear wheels 48RL and 48RR are driven wheels, but these wheels may also be driven by an electric motor for rear wheels.

In addition, the electric motor 14 is driven by the rotational energy of the left and right front wheels 48FL and 48FR during deceleration of the electrified vehicle 12, thereby functioning as an electric generator and performing regenerative braking. The power generated by the electric motor 14 is supplied to the battery 18 via the power control unit 16, thereby charging the battery.

The power control unit 16 performs power conversion between the battery 18 and the electric motor 14 and controls the output of the electric motor 14 in response to a command from the battery ECU 28. Although not shown in FIG. 1, the power control unit 16 includes an inverter that converts a direct current supplied from the battery 18 into a three-phase current supplied to the electric motor 14, and a converter that adjusts a voltage level of the direct current supplied to the inverter. The power control unit 16 converts the three-phase current supplied from the electric motor 14 into a direct current during regenerative braking and supplies the direct current to the battery 18.

The battery 18 is a chargeable and dischargeable direct current power supply and includes a plurality of secondary batteries such as a lithium ion battery or a nickel-hydrogen battery. Although not shown in FIG. 1, the battery 18 is provided with an SOC meter. The SOC is an abbreviation for "state of charge" and is an indicator representing a charge state of the battery. The SOC meter outputs information on the amount of charge of the battery 18 to the battery ECU 28 with the fully charged state as 100% and the fully discharged state as 0%.

The charging plug 54 provided at a distal end of a cable 52 of the charging device 50 during charging of the battery 18 is connected to the charging port 20. The charging port 20 outputs a signal indicating that the charging plug is connected to the charging port to the battery ECU 28 in a case where the charging plug 54 is connected. It should be noted that the charging device 50 is not limited to a specific charging device.

The charger 22 supplies the direct current supplied from the charging device 50 through the cable 52, the charging plug 54, and the charging port 20 to the battery 18 in response to a command from the battery ECU 28 in a case where the charging plug 54 is connected to the charging port 20, thereby charging the battery. The charging of the battery 18 is controlled by the charger 22 being controlled by the battery ECU 28. It should be noted that the charging device 50 may be an alternating current charging device that supplies an alternating current, and in this case, a charging plug provided at a distal end of an alternating current cable (not shown) is connected to an alternating current inlet of the charging port 20.

The driving assistance ECU 30 is a central control device that executes driving assistance controls such as remote parking control, collision avoidance assistance control, and following inter-vehicle distance control. The remote parking control includes a remote parking-in mode and a remote parking-out mode, and the control is started by starting a remote parking application installed in the communication terminal device 44. The mode of the remote parking control is selected by tapping a selection switch displayed on the monitor of the communication terminal device 44. It should be noted that the remote parking-in mode may be omitted.

In a case where the remote parking application is started, the communication terminal device 44 wirelessly communicates with the wireless communication device 26 of the control system 24 by using the short-range communication network 40 and transmits a signal indicating that the remote parking application is started to the wireless communication device 26. When a connection capable of transmitting and receiving a signal with the wireless communication device 26 is established, the communication terminal device 44 transmits to the wireless communication device 26 a signal indicating that the connection has been established.

Further, in a case where the remote parking-in mode is selected, the communication terminal device 44 transmits a signal indicating that the remote parking-in mode is selected to the wireless communication device 26, and in a case where the remote parking-out mode is selected, the communication terminal device 44 transmits a signal indicating that the remote parking-out mode is selected to the wireless communication device 26. In a case where the signal indicating that the remote parking-in mode is selected is received, the wireless communication device 26 outputs the signal indicating that the remote parking-in mode is selected to the driving assistance ECU 30. Similarly, in a case where the signal indicating that the remote parking-out mode is selected is received, the wireless communication device 26 outputs the signal indicating that the remote parking-out mode is selected to the driving assistance ECU 30.

Although not shown in FIG. 1, a plurality of camera sensors and a plurality of radar sensors are connected to the driving assistance ECU 30. The camera sensor and the radar sensor function as an object information acquisition device that acquires object information around the electrified vehicle 12.

The drive ECU 32 outputs a command signal to the battery ECU 28 such that the driving force generated by the electric motor 14 changes in response to a driving operation by the driver in a normal state. In addition, in a case where the signal of the target driving force is received from the driving assistance ECU 30, the drive ECU 32 outputs the command signal to the battery ECU 28 such that the driving force generated by the electric motor 14 is the target driving force.

Although not shown in FIG. 1, a brake device that applies a braking force to the front wheels 48FL and 48FR and the rear wheels 48RL and 48RR to decelerate the electrified vehicle 12 by braking is connected to the brake ECU 34. The brake ECU 34 controls the brake device such that the braking force generated by the brake device changes in response to a braking operation by the driver in a normal state, and performs automatic braking by controlling the brake device based on the command signal in a case where the command signal is received from the driving assistance ECU 30.

Although not shown in FIG. 1, the EPS/ECU 36 is connected to the EPS device. The EPS/ECU 36 controls the steering assist torque by controlling the EPS device in a well-known manner in the related art based on the steering torque and the vehicle speed, thereby reducing the steering burden on the driver. In addition, the EPS/ECU 36 can steer, as necessary, the front wheels 48FL and 48FR, which are steering wheels, by controlling the EPS device. Therefore, the EPS/ECU 36 and the EPS device function as an automatic steering device by cooperating with each other.

In the remote parking control, the electrified vehicle 12 is moved by autonomous driving by outputting the command signal from the driving assistance ECU 30 to the drive ECU 32, the brake ECU 34, and the EPS/ECU 36. In particular, in the remote parking-in mode, the electrified vehicle 12 is moved to the target parking-in position by autonomous driving along a target parking-in route selected by the user or a registered parking-in route. In the remote parking-out mode, the electrified vehicle 12 is moved to the target parking-out position by autonomous driving along a target parking-out route selected by the user or a registered parking-out route.

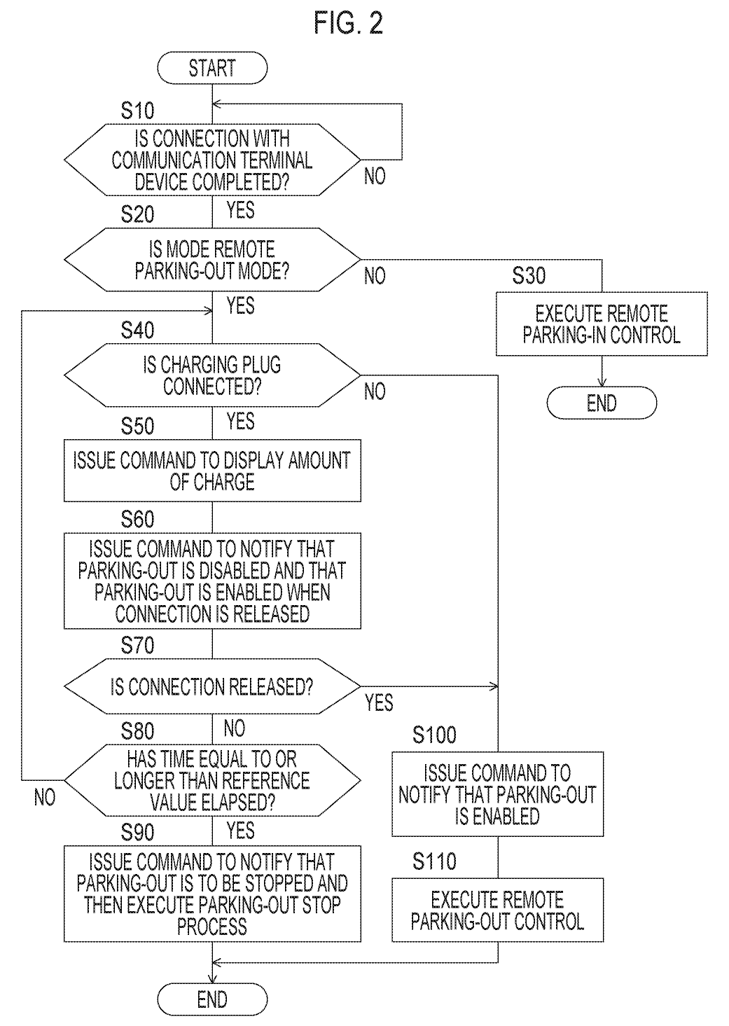

In the embodiment, the ROM of the driving assistance ECU 30 stores the remote parking control program corresponding to the flowchart shown in FIG. 2. In a case where the signal indicating that the remote parking application is started in the communication terminal device 44 is received from the wireless communication device 26, the CPU of the driving assistance ECU 30 starts the remote parking control program and repeatedly executes the remote parking control program at predetermined time intervals.

### Remote Parking Control

First, in S10, the CPU determines whether the wireless communication device 26 has completed the connection with the communication terminal device 44 such that the signal can be transmitted and received. In a case of the negative determination, S10 is performed again, and in a case of the positive determination, the present control proceeds to S20.

In S20, the CPU determines whether the mode of the remote parking control is the remote parking-out mode. In a case of the positive determination, the present control proceeds to S40, and in a case of the negative determination, that is, in a case where it is determined that the mode of the remote parking control is the remote parking-in mode, the present control proceeds to S30.

In S30, the CPU executes the remote parking-in control by outputting the command signal to the drive ECU 32, the brake ECU 34, and the EPS/ECU 36. In the remote parking-in control, the electrified vehicle 12 is moved to the target parking-in position by autonomous driving along the target parking-in route selected by the user or the registered parking-in route in a well-known manner in the related art.

In S40, the CPU determines whether the charging plug is connected to the charging port 20 by acquiring the information on the connection between the charging port 20 and the charging plug of the charging device from the battery ECU 28. In a case of the negative determination, the present control proceeds to S100, and in a case of the positive determination, the present control proceeds to S50.

In S50, the CPU acquires the information on the amount of charge of the battery 18 from the battery ECU 28 and transmits the command to display the amount of charge of the battery 18 on the monitor to the communication terminal device 44 via the wireless communication device 26. As a result, the user is notified of the amount of charge of the battery 18. It should be noted that the amount of charge of the battery 18 may be always displayed on the monitor during the execution of the remote parking control.

In S60, the CPU transmits the command to display the following information of the two warnings on the monitor to the communication terminal device 44 via the wireless communication device 26. As a result, the user is notified of the two warnings.

"Parking-out is disabled because the charging plug is connected to the charging port."

"Parking-out is enabled after disconnecting the charging plug from the charging port."

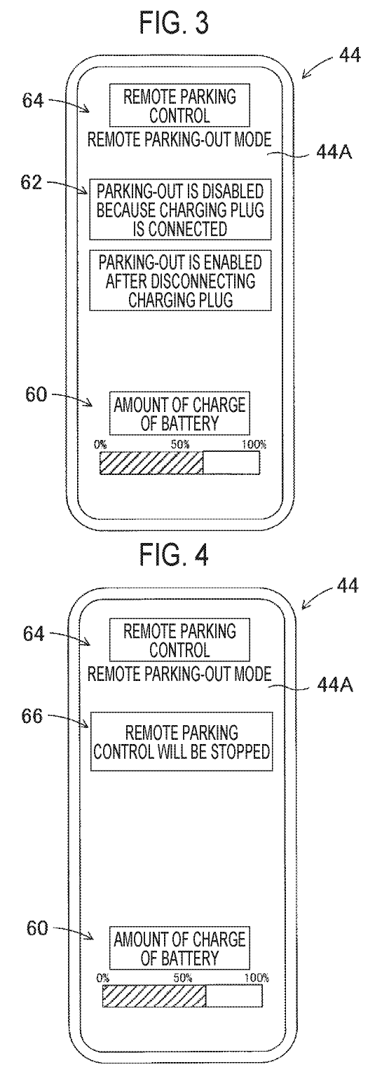

For example, FIG. 3 shows the communication terminal device 44 in which the amount of charge 60 of the battery 18 and the information 62 of the two warnings are displayed on the monitor 44A. In FIG. 3, information 64 indicating that the mode of the remote parking control is the remote parking-out mode is also displayed.

In S70, the CPU determines whether the charging plug is disconnected from the charging port 20 by acquiring the information on the connection between the charging port 20 and the charging plug of the charging device from the battery ECU 28. In a case of the positive determination, the present control proceeds to S100, and in a case of the negative determination, the present control proceeds to S80.

In S80, the CPU transmits the command to display the information of the two warnings on the monitor by performing S60 and determines whether a reference value (positive constant) or more of time has elapsed from the start of the notification of the two warnings. In a case of the negative determination, the present control returns to S40, and in a case of the positive determination, the present control proceeds to S90.

In S90, the CPU transmits the command to display the information that the remote parking control in the remote parking-out mode is to be stopped on the monitor to the communication terminal device 44 via the wireless communication device 26. As a result, the user is notified that the remote parking control is to be stopped. Thereafter, the CPU executes the process of stopping the remote parking control in the remote parking-out mode.

For example, FIG. 4 shows the communication terminal device 44 in which the amount of charge 60 of the battery 18 and the information 66 that the remote parking control in the remote parking-out mode is to be stopped are displayed on the monitor 44A. In FIG. 4, information 64 indicating that the mode of the remote parking control is the remote parking-out mode is also displayed.

In S100, the CPU transmits the command to display the information that the remote parking-out is possible on the monitor to the communication terminal device 44 via the wireless communication device 26. As a result, the user is notified that the remote parking-out is possible.

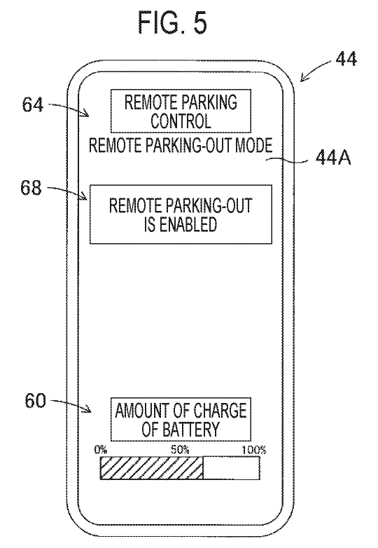

For example, FIG. 5 shows the communication terminal device 44 in which the amount of charge 60 of the battery 18 and the information 68 that the remote parking-out is possible are displayed on the monitor 44A. In FIG. 5, information 64 indicating that the mode of the remote parking control is the remote parking-out mode is also displayed.

In S110, the CPU executes the remote parking-out control by outputting the command signal to the drive ECU 32, the brake ECU 34, and the EPS/ECU 36. In the remote parking-out control, the electrified vehicle 12 is moved to the target parking-out position by autonomous driving along the target parking-out route selected by the user or the registered parking-out route in a well-known manner in the related art.

### Example of Operation of Embodiment

Examples of the operation of the embodiment will be described for various cases in which the connection between the wireless communication device 26 and the communication terminal device 44 is completed such that the signal can be transmitted and received, the mode of the remote parking control is the remote parking-out mode, and the connection status between the charging port 20 and the charging plug is different.

1. Case where Charging Plug is Not Connected to Charging Port 20

In S40, the negative determination is made, so that in S100, the user is notified that the remote parking-out is possible, and in S110, the remote parking-out control is executed.

2. Case where Charging Plug is Connected to Charging Port 20 and Connection is Released

In S40, the positive determination is made, and S50 and S60 are performed, so that the user is notified of the amount of charge of the battery 18 and the two warnings are notified. In S70, the positive determination is made, so that in S100, the user is notified that the remote parking-out is possible, and in S110, the remote parking-out control is executed.

It should be noted that, even in a case where the negative determination is made in S70, the negative determination is made in S80 and S40, so that S100 and S110 are performed.

3. Case where Charging Plug is Connected to Charging Port 20 and Connection is Not Released

As in the case of 2, in S40, the positive determination is made, and S50 and S60 are performed, so that the user is notified of the amount of charge of the battery 18 and the two warnings are notified. Meanwhile, in S70, the negative determination is made, and in S80, the positive determination is made. Therefore, in S90, the user is notified that the remote parking control is to be stopped, and then the process of stopping the remote parking control in the remote parking-out mode is executed.

As described above, according to the embodiment, in a case where it is determined that the charging plug is connected to the charging port 20 after the wireless connection between the control system 24 and the communication terminal device 44 is completed (S10) (S40), the warning is notified to the user (S60). The warning includes that parking-out of the electrified vehicle by the remote parking-out control is disabled and that parking-out of the electrified vehicle by the remote parking-out control is enabled in a case where the connection between the charging plug and the charging port is released.

Therefore, since the warning is notified to the user after the wireless connection between the control system 24 and the communication terminal device 44 is completed, the user can reliably recognize that the charging plug is connected to the charging port 20. In addition, since the warning includes that parking-out of the electrified vehicle by the remote parking-out control is disabled, it is possible to prevent the user from parking out the electrified vehicle by the remote parking-out control in a situation where the charging plug is connected to the charging port. Further, since the warning includes that parking-out of the electrified vehicle by the remote parking-out control is enabled in a case where the connection between the charging plug and the charging port is released, the user can determine that parking-out of the electrified vehicle is enabled by releasing the connection between the charging plug and the charging port. Therefore, the user can determine a timing of releasing the connection between the charging plug and the charging port.

In addition, according to the embodiment, in a case where it is determined that the connection between the charging plug and the charging port 20 is released (S40), the user is notified that parking-out of the electrified vehicle 12 is possible by the remote parking-out control (S100). Therefore, the user can determine that parking-out of the electrified vehicle by the remote parking-out control is enabled.

In addition, according to the embodiment, in addition to the warning, the amount of charge of the battery is notified to the user (S50, S60). Therefore, in a case where it is determined that the amount of charge of the battery is sufficient, the user performs the parking out of the electrified vehicle by the remote parking-out control, but in a case where it is determined that the amount of charge of the battery is insufficient, the user can hold the parking out of the electrified vehicle by the remote parking-out control until the amount of charge is sufficient.

In addition, according to the embodiment, before the remote parking-out control is executed in response to the command from the communication terminal device 44 (S110), it is determined whether the charging plug is connected to the charging port 20 (S40). Therefore, it is possible to prevent the user from parking out the electrified vehicle by the remote parking-out control before it is determined whether the charging plug is connected to the charging port.

In addition, according to the embodiment, even after a reference value or more of time has elapsed from the start of the notification of the warning to the user (S80), in a case where it is determined that the connection between the charging plug and the charging port 20 is not released (S40), the user is notified that the remote parking-out control is to be stopped, and then the remote parking-out control is stopped (S90). Therefore, it is possible to prevent a determination as to whether the charging plug is connected to the charging port from continuing for an excessively long period of time, and the user can recognize in advance, before the remote parking-out control is stopped, that the remote parking-out control is to be stopped.

In the above, the present disclosure has been described in detail with reference to specific embodiments, but the present disclosure is not limited to the above-described embodiments, and it will be apparent to those skilled in the art that various other embodiments are possible within the scope of the present disclosure.

For example, in the above-described embodiment, in a case where the positive determination is made in S70, S100 is performed. However, in a case where the connection between the charging port 20 and the charging plug is released, the negative determination is made in S40, and S100 is performed. Therefore, S70 may be omitted.

In addition, in the above-described embodiment, in a case where S60 is performed, S70 is performed. After S60 is performed, "Disconnect the charging plug from the charging port?" may be displayed on the monitor of the communication terminal device 44, and in a case where the user selects "Yes" and consents, the control returns to S40, and in a case where the user selects "No" and does not consent, the control may proceed to S90.

In addition, in the above-described embodiment, in S90, the user is notified that the remote parking control is to be stopped, and then the process of stopping the remote parking control in the remote parking-out mode is executed. However, in a case where the user is notified that the remote parking control is to be stopped and "Stop the remote parking control?" is displayed on the monitor of the communication terminal device 44, and the user selects "Yes" and consents, the remote parking control in the remote parking-out mode may be stopped, and in a case where the user selects "No" and does not consent, the above display may be repeated.

In addition, in the above-described embodiment, in S50, S60, S90, and S100, the user is notified of the visual information by displaying the visual information on the monitor of the communication terminal device 44. However, the notification to the user may be performed by emitting the auditory information from the speaker, or may be performed by both the display of the visual information and the emission of the auditory information.

Further, in the above-described embodiment, the remote parking-out control is executed as the remote parking-out mode, which is a part of the remote parking control, but S20 and S30 may be omitted, and only the remote parking-out control may be executed.

What is claimed is:

1. A remote parking-out control device for an electrified vehicle in which a battery is charged when a charging plug of a charging device is connected to a charging port, the remote parking-out control device comprising a control unit mounted on the electrified vehicle, the control unit being configured to establish a wireless connection to a communication terminal device operated by a user and to execute remote parking-out control in response to a command from the communication terminal device,
wherein the control unit is configured to, after the wireless connection with the communication terminal device is completed, in a case where determination is made that a connection between the charging plug and the charging port is established, issue a command to the communication terminal device to notify the user of a warning that parking-out of the electrified vehicle by the remote parking-out control is disabled, and that the parking-out of the electrified vehicle by the remote parking-out control is enabled in a case where the connection between the charging plug and the charging port is released.

2. The remote parking-out control device according to claim 1, wherein the control unit is configured to, in a case where determination is made that the connection between the charging plug and the charging port is released, issue a command to the communication terminal device to notify the user that the parking-out of the electrified vehicle by the remote parking-out control is enabled.

3. The remote parking-out control device according to claim 1, wherein the control unit is configured to, in addition to the warning, issue a command to the communication terminal device to notify the user of an amount of charge of the battery.

4. The remote parking-out control device according to claim 1, wherein the control unit is configured to, before executing the remote parking-out control in response to the command from the communication terminal device, determine whether the charging plug is connected to the charging port.

5. The remote parking-out control device according to claim 1, wherein the control unit is configured to, in a case where determination is made that the connection between the charging plug and the charging port is not released even after a time equal to or longer than a reference value that is predetermined has elapsed from a time when notification of the warning to the user is started, issue a command to the communication terminal device to notify the user that the remote parking-out control is to be stopped, and then stop the remote parking-out control.
